(19) United States
(12) Patent Application Publication
(10) Pub. No.: US 2007/0191585 A1
(43) Pub. Date: Aug. 16, 2007

(54) Organic polymer film and method for forming the same

(76) Inventor: Nobuo Aoi, Hyogo (JP)

Correspondence Address: MCDERMOTT WILL & EMERY LLP, 600 13TH STREET, NW, WASHINGTON, DC, 20005-3096, US

(21) Appl. No.: 11/705,734

(22) Filed: Feb. 14, 2007

(30) Foreign Application Priority Data
Feb. 14, 2006 (JP) 2006-036266

(51) Int. Cl. C08G 73/08

(52) U.S. Cl. 528/327

(57) ABSTRACT

A method for forming an organic polymer film includes a step of polymerizing a monomer including an adamantane derivative in which a substituent group having a carbon number of 1 or more, a functional group or a functional group bonded to a substituent group is bonded to at least the 1-, 3-, 5- and 7-positions of an adamantane skeleton.

### BACKGROUND OF THE INVENTION

The present invention relates to an organic polymer film and a method for forming the same, and more particularly, it relates to an interlayer insulating film having a low dielectric constant and high mechanical strength and a method for forming the same.

As an interlayer insulating film for a very large scale integrated (LSI) circuit or the like, an organic polymer film made of a polymer obtained by polymerizing aromatic molecules is conventionally used for improving the heat resistance. Specifically, an organic polymer film including a polyimide derivative, a polyallyl ether derivative, a polyquinoline derivative or a polypara-xylene derivative is known. Since such a polymer film includes carbon as a principal component, the polarizability of the constituent molecules is lower as compared with that of a SiO₂-based interlayer insulating film, and hence, such a film is regarded as a promising low-k interlayer insulating film.

Specifically, the dielectric constant of an organic polymer including carbon as a principal component is, for example, approximately 2.4 through 3.0, which is lower than the dielectric constant of a SiO₂-based interlayer insulating film of approximately 3.3 through 4.5. However, even in using a SiO₂-based material, an organic SOG (spin on glass) interlayer insulating film including an organic component is known to have a dielectric constant of approximately 2.9.

Although a low dielectric constant has been realized in such a conventional organic polymer film because of its low polarizability as compared with SiO₂, examination is recently made for making the film porous for further lowering the dielectric constant. When the film is made porous, however, although the dielectric constant is largely lowered, its adhesion property and mechanical strength are lowered. This is because of a theoretic defect that a low dielectric constant attained by the porous film is realized by lowering the crosslink density of the organic polymer. The mechanical strength of an organic polymer film is higher as the crosslink density is higher, and when the crosslink density is lowered by making the film porous, not only the hardness of the material itself is lowered but also the glass transition temperature is lowered. When the adhesion property and the mechanical strength are lowered, for example, in a multilayered interconnect structure, the interconnect structure is broken in planarization through chemical mechanical polishing. On the other hand, when the glass transition temperature is lowered, an interlayer insulating film made of the organic polymer film is softened through backing performed after the formation of the interlayer insulating film, resulting in deforming or breaking the multilayered interconnect structure.

In order to realize a low dielectric constant of an organic polymer film without lowering the adhesion property and the mechanical strength, a method in which molecules having holes therein are synthesized and the thus obtained molecules are polymerized so as to form an organic polymer film having a three-dimensional polymeric structure including three-dimensional holes has been proposed (see, for example, Japanese Laid-Open Patent Publication No. 2001-332543). In the method described in this publication, a three-dimensional polymeric structure including three-dimensional holes of a molecular size is formed by copolymerizing, for example, a three-dimensional polymeric monomer having four functional groups and a straight-chain two-dimensional polymeric monomer having two functional groups to be chemically bonded to the functional groups of the three-dimensional polymeric monomer.

### SUMMARY OF THE INVENTION

In a polymerization reaction between a low-molecular weight three-dimensional polymeric monomer and a two-dimensional polymeric monomer, since the volume of the two-dimensional polymeric monomer is smaller, a structure in which the three-dimensional polymeric monomer and the two-dimensional polymeric monomer are penetrated into each other tends to be formed. Therefore, the resultant film density is high and hence the dielectric constant is disadvantageously high. Furthermore, in the case where benzimidazole is used as a basic skeleton of the polymer, the hygroscopicity is high because of polarization of NH in imidazole. As a result, degas is caused so as to disadvantageously increase the via resistance in a multilayered interconnect structure and to increase the dielectric constant. Also, in the case where a low-molecular weight monomer is used, the polymerization temperature falls in a temperature range substantially the same as the vaporization temperature of a two-dimensional polymeric amine derivative monomer, that is, a two-dimensional polymeric monomer, and therefore, the polymerization reaction proceeds simultaneously with the vaporization of the two-dimensional polymeric amine derivative. Accordingly, the quantity of the two-dimensional polymeric amine derivative monomer is reduced through the vaporization, which inhibits the polymerization reaction, and hence, there arises a problem that a high-molecular weight polymer cannot be formed. As a result, the glass transition temperature and the mechanical strength are further disadvantageously lowered.

In consideration of the aforementioned conventional problems, an object of the invention is providing an organic polymer film having high mechanical strength and a low dielectric constant and a method for forming the same.

In order to achieve the object, the present inventor has made various examinations, resulting in finding that an amine derivative monomer having a three-dimensional polymeric adamantane skeleton can be produced through a reaction between a two-dimensional polymeric amine derivative monomer and a carboxyl group of a carboxylic acid derivative monomer having a three-dimensional polymeric adamantane skeleton. Therefore, according to the present invention, the thus obtained amine derivative monomer having the three-dimensional polymeric adamantane skeleton is used for a copolymerization reaction with a carboxylic acid derivative monomer having a three-dimensional polymeric adamantane skeleton, so as to provide an organic polymer film with high mechanical strength and a low dielectric constant and a method for forming the same.

The amine derivative monomer having the three-dimensional polymeric adamantane skeleton used in this invention has a larger volume than a two-dimensional polymeric amine derivative monomer, and therefore, mutual penetration between the amine derivative monomer having the three-dimensional polymeric adamantane skeleton and the carboxylic acid derivative monomer having the three-dimensional polymeric adamantane skeleton is suppressed. Accordingly, a polymerization reaction can be proceeded while keeping a large space between the three-dimensional polymeric monomers. In contrast, in the case where a two-dimensional polymeric monomer with a smaller volume is polymerized with a three-dimensional polymeric monomer, the polymerization reaction is proceeded while the two-dimensional polymeric monomer penetrating into a space of an oligomer formed with the procedure of the polymerization reaction, and hence, a film with a high density is resultantly formed. On the other hand, in the case where the amine derivative monomer having the three-dimensional polymeric adamantane skeleton with a larger volume is used for polymerization of the three-dimensional polymeric monomers, the amine derivative monomer having the three-dimensional polymeric adamantane skeleton is minimally penetrated into a space of an oligomer formed with the procedure of the polymerization reaction. In addition, since the amine derivative monomer having the three-dimensional polymeric adamantane skeleton has a functional group bonded to an aromatic substituent group made of sp² carbon alone, the aromatic substituent group bonded to the functional group is rigid and minimally deformed. Therefore, it is never shrunk even through high temperature backing, and hence, an organic polymer film with a low density and a high crosslink density can be formed.

In this manner, according to the present invention, an organic polymer film with high mechanical strength and a low dielectric constant can be obtained. Simultaneously, an organic polymer film with hygroscopicity suppressed can be obtained.

### BRIEF DESCRIPTION OF THE DRAWINGS

FIG. 1 is a diagram for showing an exemplified synthesis procedure for a second monomer used in an embodiment of the invention;

FIG. 2 is a diagram for showing another exemplified synthesis procedure for the second monomer used in the embodiment of the invention;

FIG. 3 is a diagram for showing another exemplified synthesis procedure for the second monomer used in the embodiment of the invention;

FIG. 4 is a diagram for showing exemplified copolymerization of a first monomer and a second monomer performed in the embodiment of the invention;

FIG. 5 is a diagram for showing another exemplified copolymerization of a first monomer and a second monomer performed in the embodiment of the invention;

FIG. 6 is a diagram for showing exemplified copolymerization of a three-dimensional polymeric monomer and a two-dimensional polymeric monomer performed as a comparative example in the embodiment of the invention;

FIG. 7 is a conceptual diagram for explaining that a first monomer and a second monomer are minimally penetrated into each other in the embodiment of the invention; and

FIG. 8 is a diagram of an apparatus used for spin coating performed in an example of the embodiment of the invention.

### DETAILED DESCRIPTION OF THE INVENTION

The present invention provides an organic polymer film with high mechanical strength and a low dielectric constant obtained through copolymerization of a first monomer and a second monomer and also provides a method for forming the same. The first monomer is a monomer including an adamantane derivative in which a substituent group having a carbon number of 1 or more, a functional group or a functional group bonded to a substituent group is bonded to at least three positions out of the 1-, 3-, 5- and 7-positions of an adamantane skeleton, at least one of functional groups is a carboxyl group, and a substituent group bonded to a functional group is an aromatic group. The second monomer is a monomer including an adamantane derivative in which a substituent group having a carbon number of 1 or more, a functional group or a functional group bonded to a substituent group is bonded to at least three positions out of the 1-, 3-, 5- and 7-positions of an adamantane skeleton, at least one of functional groups is a hydroxyl group, and a substituent group bonded to a functional group is an aromatic group.

Specifically, in a method for forming an organic polymer film according to an embodiment of the invention, a monomer including a carboxylic acid derivative having an adamantane skeleton represented by a general formula of Chemical Formula 61 below is used as the first polymer, and a monomer including an amine derivative having an adamantane skeleton represented by a general formula of Chemical Formula 64 below is used as the second monomer. One or plural kinds of first monomer and one or plural kinds of second monomer are copolymerized with each other, so as to form an interlayer insulating film with high mechanical strength and a low dielectric constant. Furthermore, an organic polymer film according to the embodiment of the invention is an organic polymer film made of a copolymer of one or plural kinds of first monomer and one or plural kinds of second monomer.

At this point, the first monomer and the second monomer will be specifically described.

—First Monomer (Carboxylic Acid Derivative having Adamantane Skeleton)—

First, the first monomer is a three-dimensional polymeric monomer, and includes a carboxylic acid derivative having an adamantane skeleton represented by the general formula of the following Chemical Formula 61:

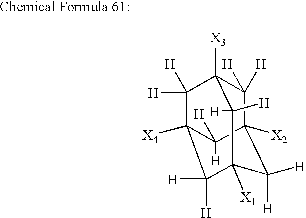

wherein each of X₁, X₂, X₃ and X₄ is one selected from the group consisting of a substituent group represented by the following Chemical Formula 62, a substituent group represented by the following Chemical Formula 63, a hydrogen atom, an aliphatic group and an aromatic group, and at least one of X₁, X₂, X₃ and X₄ is a substituent group represented by the following Chemical Formula 62 or 63:

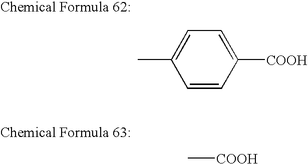

At this point, possible combinations of X₁ through X₄ are listed in Table 1 below.

TABLE 1

| 1a | X1 =, X2 =, X3 =, X4 = | 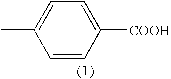 | | |
|---|---|---|---|---|
| 1b | X1 =, X2 =, X3 = | 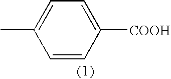 | X4 = | hydrogen, aliphatic group oraromatic group |
| 1c | X1 =, X2 = | 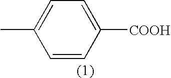 | X3 =, X4 = | hydrogen, aliphatic group oraromatic group |
| 1d | X1 = | 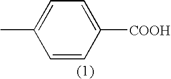 | X2 =, X3 =, X4 = | hydrogen, aliphatic group oraromatic group |
| 1e | X1 =, X2 =, X3 =, X4 = | —COOH | | |
| | | (2) | | |
| 1f | X1 =, X2 =, X3 = | —COOH | X4 = | hydrogen, aliphatic group or |
| | | (2) | | aromatic group |
| 1g | X1 =, X2 = | —COOH | X3 =, X4 = | hydrogen, aliphatic group or |
| | | (2) | | aromatic group |
| 1h | X1 = | —COOH | X2 =, X3 =, X4 = | hydrogen, aliphatic group or |
| | | (2) | | aromatic group |

As shown in Table 1, the possible combinations of X₁ through X₄ are combinations 1a through 1h. Specifically, each of X₁ through X₄ is a substituent group represented by Chemical Formula (1) (corresponding to Chemical Formula 62; which also applies to the description below) in the combination 1a; each of X₁ through X₃ is the substituent group represented by Chemical Formula (1) and X₄ is hydrogen, an aliphatic group or an aromatic group in the combination 1b; each of X₁ and X₂ is the substituent group represented by Chemical Formula (1) and each of X₃ and X₄ is hydrogen, an aliphatic group or an aromatic group in the combination 1c; X₁ is the substituent group represented by Chemical Formula (1) and each of X₂ through X₄ is hydrogen, an aliphatic group or an aromatic group in the combination 1d; each of X₁ through X₄ is a substituent group represented by Chemical Formula (2) (corresponding to Chemical Formula 63; which also applies to the description below) in the combination 1e; each of X₁ through X₃ is the substituent group represented by Chemical Formula (2) and X₄ is hydrogen, an aliphatic group or an aromatic group in the combination 1f; each of X₁ and X₂ is the substituent group represented by Chemical Formula (2) and each of X₃ and X₄ is hydrogen, an aliphatic group or an aromatic group in the combination 1g; and X₁ is the substituent group represented by Chemical Formula (2) and each of X₂ through X₄ is hydrogen, an aliphatic group or an aromatic group in the combination 1h.

—Second Monomer (Amine Derivative having Adamantane Skeleton)—

The second monomer is a three-dimensional polymeric monomer, and includes an amine derivative having an adamantane skeleton represented by the general formula of the following Chemical Formula 64:

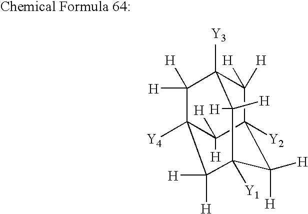

wherein each of Y₁, Y₂, Y₃ and Y₄ is one selected from the group consisting of substituent groups respectively represented by the following Chemical Formulas 65 through 72, hydrogen, an aliphatic group and an aromatic group, and at least one of Y₁, Y₂, Y₃ and Y₄ is one of the substituent groups respectively represented by the following Chemical Formulas 65 through 72:

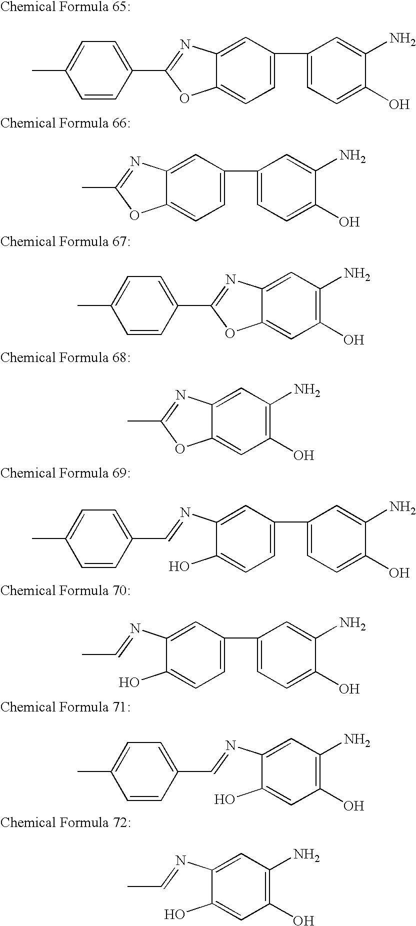

At this point, possible combinations of Y₁ through Y₄ are listed in Tables 2 and 3 below.

TABLE 2

| | | | | |
|---|---|---|---|---|
| 2a | Y1 =, Y2 =, Y3 =, Y4 = | 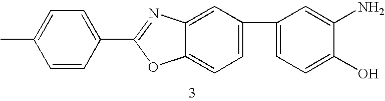 | | |
| 2b | Y1 =, Y2 =, Y3 = | 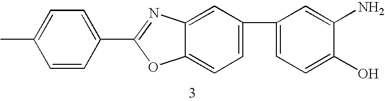 | Y4 = | hydrogen, aliphatic group oraromatic group |
| 2c | Y1 =, Y2 = | 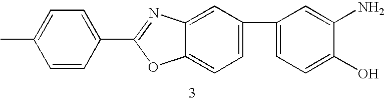 | Y3 =, Y4 = | hydrogen, aliphatic group oraromatic group |
| 2d | Y1 = | 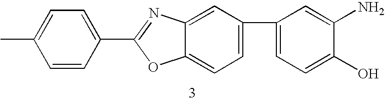 | Y2 =, Y3 =, Y4 = | hydrogen, aliphatic group oraromatic group |
| 2e | Y1 =, Y2 =, Y3 =, Y4 = | 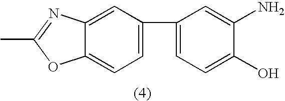 | | |
| 2f | Y1 =, Y2 =, Y3 = | 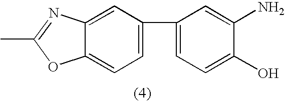 | Y4 = | hydrogen, aliphatic group oraromatic group |
| 2g | Y1 =, Y2 = | 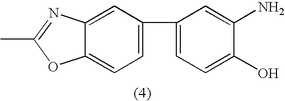 | Y3 =, Y4 = | hydrogen, aliphatic group oraromatic group |
| 2h | Y1 = | 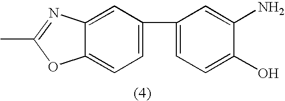 | Y2 =, Y3 =, Y4 = | hydrogen, aliphatic group oraromatic group |
| 2i | Y1 =, Y2 =, Y3 =, Y4 = | 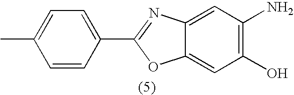 | | |
| 2j | Y1 =, Y2 =, Y3 = | 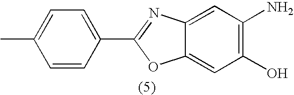 | Y4 = | hydrogen, aliphatic group oraromatic group |
| 2k | Y1 =, Y2 = | 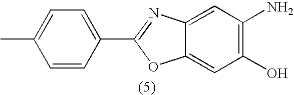 | Y3 =, Y4 = | hydrogen, aliphatic group oraromatic group |
| 2l | Y1 = | 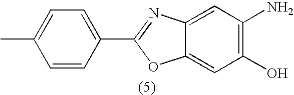 | Y2 =, Y3 =, Y4 = | hydrogen, aliphatic group oraromatic group |
| 2m | Y1 =, Y2 =, Y3 =, Y4 = | 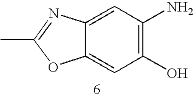 | | |
| 2n | Y1 =, Y2 =, Y3 = | 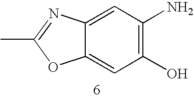 | Y4 = | hydrogen, aliphatic group oraromatic group |
| 2o | Y1 =, Y2 = | 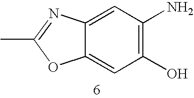 | Y3 =, Y4 = | hydrogen, aliphatic group oraromatic group |
| 2p | Y1 = | 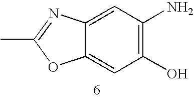 | Y2 =, Y3 =, Y4 = | hydrogen, aliphatic group oraromatic group |

TABLE 3

| | | | | |
|---|---|---|---|---|
| 3a | Y1 =, Y2 =, Y3 =, Y4 = | 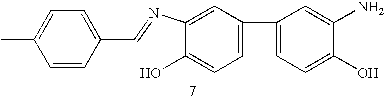 | | |
| 3b | Y1 =, Y2 =, Y3 = | 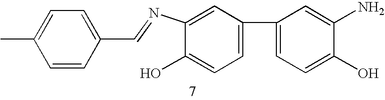 | Y4 = | hydrogen, aliphatic group oraromatic group |
| 3c | Y1 =, Y2 = | 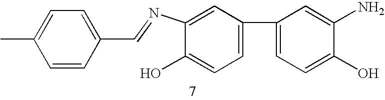 | Y3 =, Y4 = | hydrogen, aliphatic group oraromatic group |
| 3d | Y1 = | 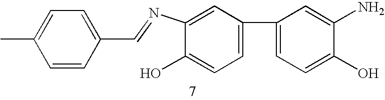 | Y2 =, Y3 =, Y4 = | hydrogen, aliphatic group oraromatic group |
| 3e | Y1 =, Y2 =, Y3 =, Y4 = | 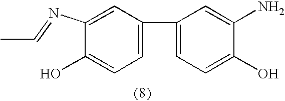 | | |
| 3f | Y1 =, Y2 =, Y3 = | 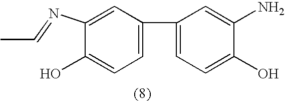 | Y4 = | hydrogen, aliphatic group oraromatic group |
| 3g | Y1 =, Y2 = | 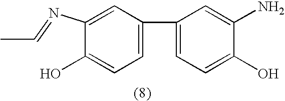 | Y3 =, Y4 = | hydrogen, aliphatic group oraromatic group |
| 3h | Y1 = | 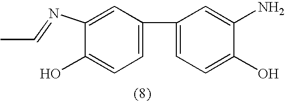 | Y2 =, Y3 =, Y4 = | hydrogen, aliphatic group oraromatic group |
| 3i | Y1 =, Y2 =, Y3 =, Y4 = | 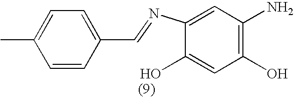 | | |
| 3j | Y1 =, Y2 =, Y3 = | 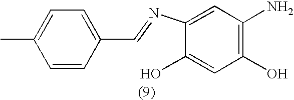 | Y4 = | hydrogen, aliphatic group oraromatic group |
| 3k | Y1 =, Y2 = | 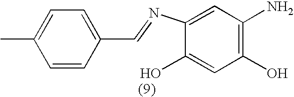 | Y3 =, Y4 = | hydrogen, aliphatic group oraromatic group |
| 3l | Y1 = | 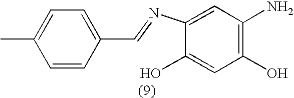 | Y2 =, Y3 =, Y4 = | hydrogen, aliphatic group oraromatic group |
| 3m | Y1 =, Y2 =, Y3 =, Y4 = | 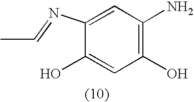 | | |
| 3n | Y1 =, Y2 =, Y3 = | 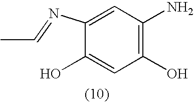 | Y4 = | hydrogen, aliphatic group oraromatic group |
| 3o | Y1 =, Y2 = | 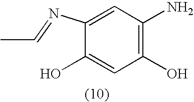 | Y3 =, Y4 = | hydrogen, aliphatic group oraromatic group |
| 3p | Y1 = | 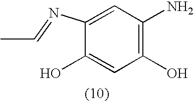 | Y2 =, Y3 =, Y4 = | hydrogen, aliphatic group oraromatic group |

First, as shown in Table 2, the possible combinations of Y₁ through Y₄ are combinations 2a through 2p. Specifically, each of Y₁ through Y₄ is a substituent group represented by Chemical Formula (3) (corresponding to Chemical Formula 65; which also applies to the description below) in the combination 2a; each of Y₁ through Y₃ is the substituent group represented by Chemical Formula (3) and Y₄ is hydrogen, an aliphatic group or an aromatic group in the combination 2b; each of Y₁ and Y₂ is the substituent group represented by Chemical Formula (3) and each of Y₃ and Y₄ is hydrogen, an aliphatic group or an aromatic group in the combination 2c; Y₁ is the substituent group represented by Chemical Formula (3) and each of Y₂ through Y₄ is hydrogen, an aliphatic group or an aromatic group in the combination 2d; each of Y₁ through Y₄ is a substituent group represented by Chemical Formula (4) (corresponding to Chemical Formula 66; which also applies to the description below) in the combination 2e; each of Y₁ through Y₃ is the substituent group represented by Chemical Formula (4) and Y₄ is hydrogen, an aliphatic group or an aromatic group in the combination 2f; each of Y₁ and Y₂ is the substituent group represented by Chemical Formula (4) and each of Y₃ and Y₄ is hydrogen, an aliphatic group or an aromatic group in the combination 2g; and Y₁ is the substituent group represented by Chemical Formula (4) and each of Y₂ through Y₄ is hydrogen, an aliphatic group or an aromatic group in the combination 2h.

Furthermore, each of Y₁ through Y₄ is a substituent group represented by Chemical Formula (5) (corresponding to Chemical Formula 67; which also applies to the description below) in the combination 2i; each of Y₁ through Y₃ is the substituent group represented by Chemical Formula (5) and Y₄ is hydrogen, an aliphatic group or an aromatic group in the combination 2j; each of Y₁ and Y₂ is the substituent group represented by Chemical Formula (5) and each of Y₃ and Y₄ is hydrogen, an aliphatic group or an aromatic group in the combination 2k; Y₁ is the substituent group represented by Chemical Formula (5) and each of Y₂ through Y₄ is hydrogen, an aliphatic group or an aromatic group in the combination 2l; each of Y₁ through Y₄ is a substituent group represented by Chemical Formula (6) (corresponding to Chemical Formula 68; which also applies to the description below) in the combination 2m; each of Y₁ through Y₃ is the substituent group represented by Chemical Formula (6) and Y₄ is hydrogen, an aliphatic group or an aromatic group in the combination 2n; each of Y₁ and Y₂ is the substituent group represented by Chemical Formula (6) and each of Y₃ and Y₄ is hydrogen, an aliphatic group or an aromatic group in the combination 2o; and Y₁ is the substituent group represented by Chemical Formula (6) and each of Y₂ through Y₄ is hydrogen, an aliphatic group or an aromatic group in the combination 2p.

Moreover, possible combinations 3a through 3p of Y₁ through Y₄ shown in Table 3 are similar to the combinations 2a through 2p shown in Table 2 and are different from the combinations shown in Table 2 merely in using substituent groups respectively represented by Chemical Formulas (7) through (10) (respectively corresponding to Chemical Formulas 69 through 72) instead of the substituent groups respectively represented by Chemical Formulas (3) through (6).

—Synthesis Method for Second Monomer (Amine Derivative having Adamantane Skeleton)—

Now, a method for synthesizing the second monomer including the amine derivative having the adamantane skeleton will be described.

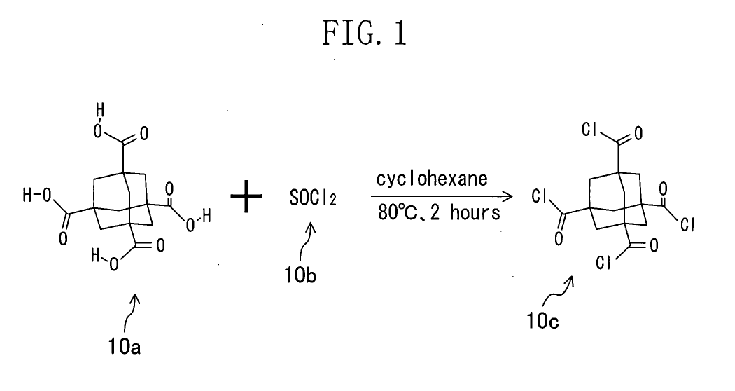

FIGS. 1 through 3 are diagrams for explaining examples of the synthesis method for the second monomer, and specifically, synthesis performed when the combination 2a of Table 2 is employed for X₁ through X₄ and synthesis performed when the combination 3a of Table 3 is employed for X₁ through X₄ are explained.

First, as shown in FIG. 1, a carboxylatophenyladamantane derivative 10a is synthesized in accordance with a method described in Macromolecules 1994, 27 by V. R. Reichert et al., pp. 7015-7023. After causing a reaction between the carboxylatophenyladamantane derivative 10a and SOCl₂ 10b in cyclohexane at a temperature of 80° C. for 2 hours, a solid 10c is isolated.

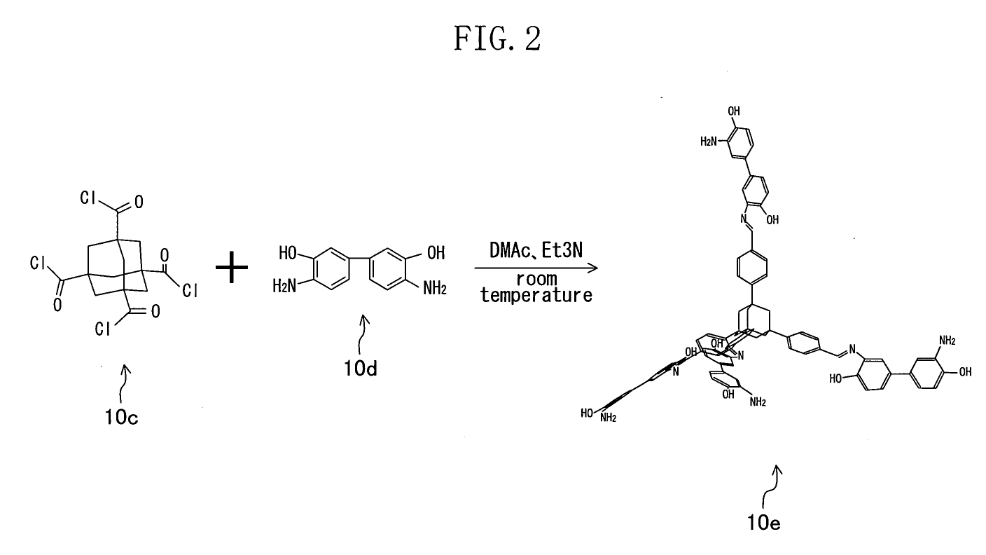

Next, as shown in FIG. 2, the isolated solid 10c is allowed to react with dihydroxydiaminobiphenyl 10d in dimethyl acetamide (DMAc) in the presence of triethylamine (Et3N) at room temperature, thereby synthesizing an amine derivative 10e having an adamantane skeleton resulting from the combination 3a.

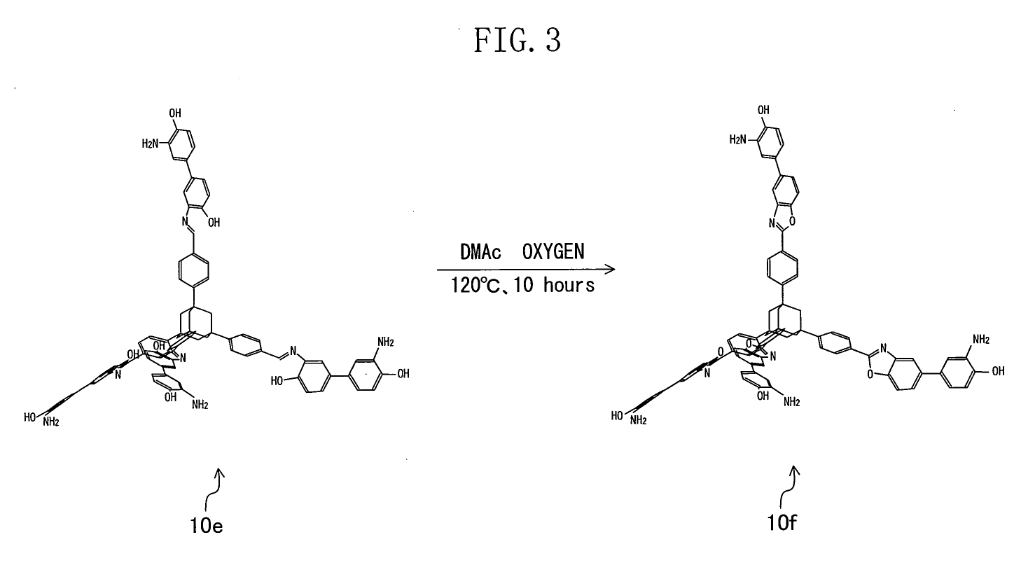

Furthermore, as shown in FIG. 3, the amine derivative 10e having the adamantane skeleton is allowed to react in dimethyl acetamide (DMAc) in an air atmosphere at a temperature of 120° C. for 10 hours, thereby synthesizing an amine derivative 10f having an adamantane skeleton resulting from the combination 2a.

When any of the other combinations apart from the combinations 2a and 3a is employed, an amine derivative can be similarly synthesized although not described herein.

—Copolymerization of First Monomer (Carboxylic Acid Derivative having Adamantane Skeleton) and Second Monomer (Amine Derivative having Adamantane Skeleton)—

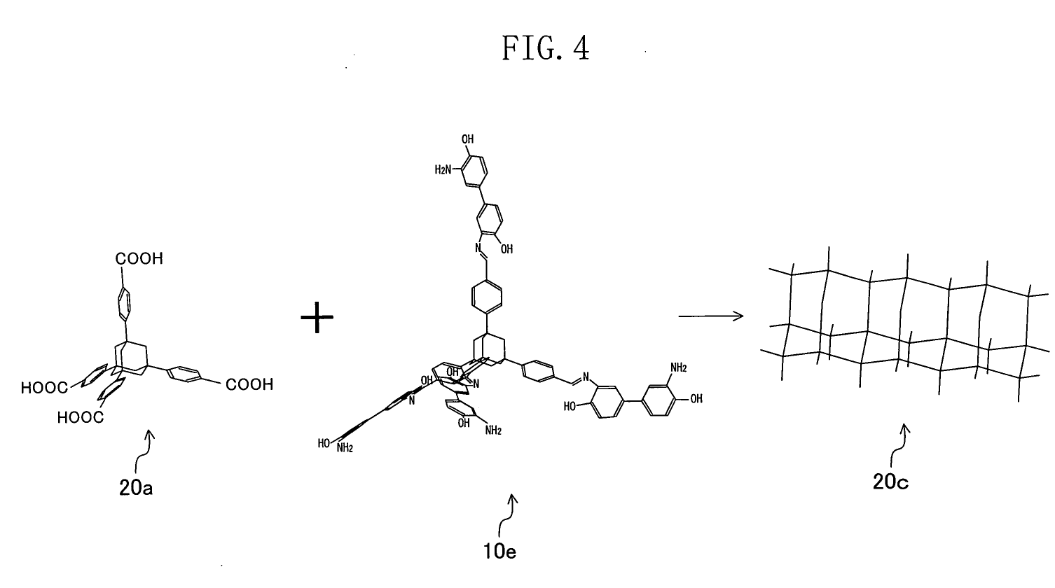

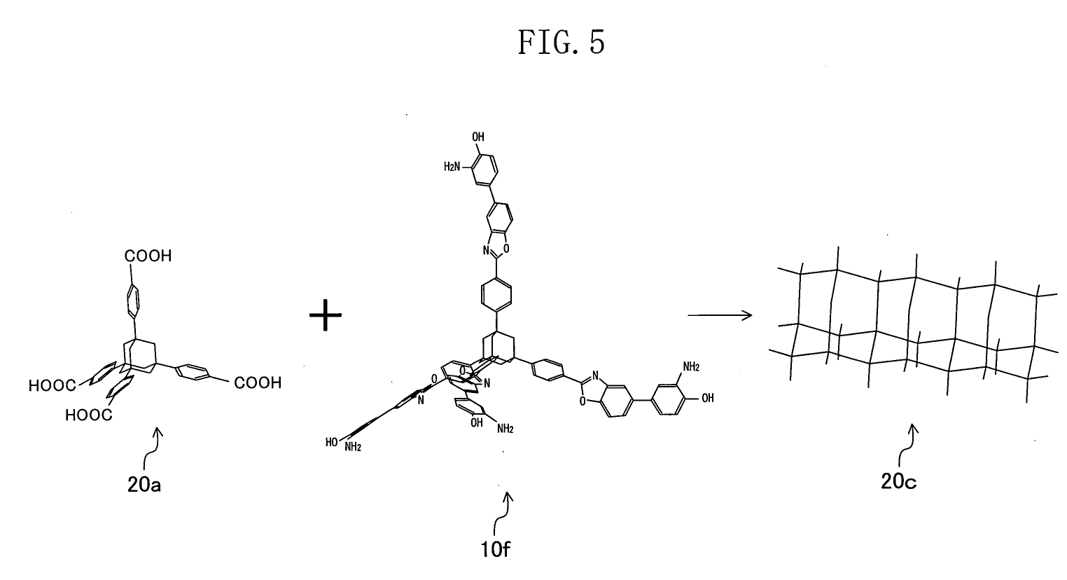

As described above, the first monomer and the second monomer are copolymerized with each other to form an organic polymer film with high mechanical strength and a low dielectric constant in the present invention. Now, the copolymerization of the first monomer and the second monomer will be described with reference to FIGS. 4 and 5.

First, as shown in FIG. 4, when a first monomer 20a including a carboxylic acid derivative having an adamantane skeleton resulting from the combination 1a of Table 1 and a second monomer 10e including the amine derivative having an adamantane skeleton resulting from the combination 3a of Table 3 are copolymerized with each other, an organic polymer film 20c having a structure in which a space is formed between the monomers with mutual penetration of the monomers suppressed can be formed.

Similarly, as shown in FIG. 5, also when the first monomer 20a including the carboxylic acid derivative having the adamantane skeleton resulting from the combination 1a of Table 1 and a second monomer 10f including an amine derivative having an adamantane skeleton resulting from the combination 2a of Table 2 are copolymerized with each other, an organic polymer film 20c having a structure in which a space is formed between the monomers with mutual penetration of the monomers suppressed can be formed.

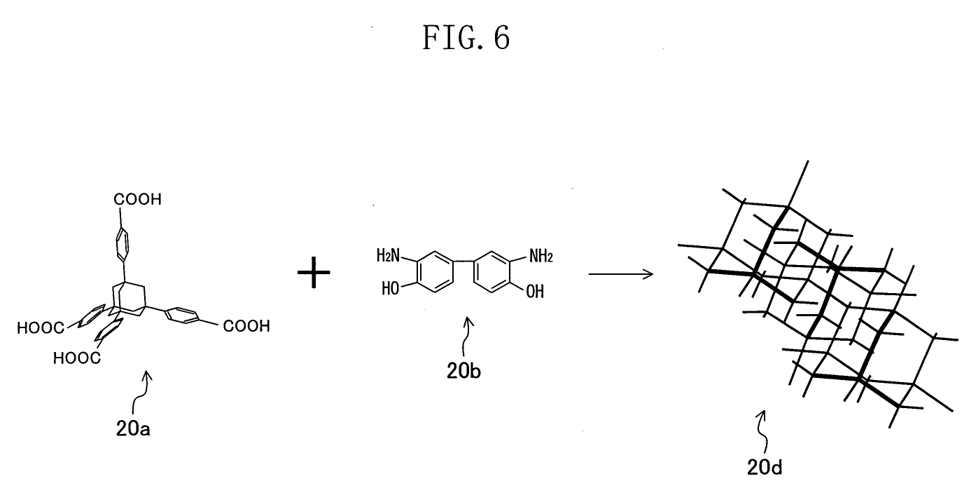

As described in “Background of the Invention”, when the carboxylic acid derivative 20a, that is, a three-dimensional polymeric monomer, and dihydroxydiaminebiphenyl 20b, that is, a two-dimensional polymeric monomer, are polymerized with each other, since the volume of the two-dimensional polymeric monomer is small, an organic polymer film having a structure 20d in which the monomers are penetrated into each other tends to be formed as shown in FIG. 6.

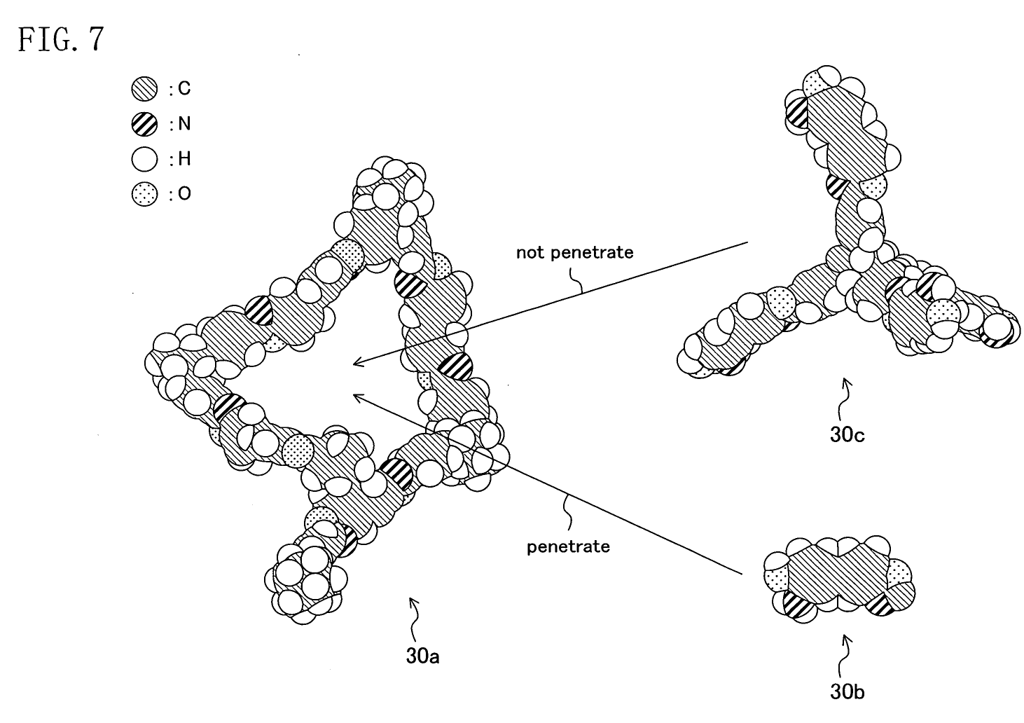

In contrast, as described with reference to FIGS. 4 and 5, when the three-dimensional polymeric monomers are polymerized with each other, a dendrimer type three-dimensional polymeric monomer 30c used in the present invention minimally penetrates into a space of an oligomer 30a formed with the procedure of the polymerization (while a conventional two-dimensional polymeric monomer 30b easily penetrates into the space) as shown in a conceptual diagram of FIG. 7. In addition, the three-dimensional polymeric amine derivative monomer having the adamantane skeleton has a functional group bonded to an aromatic substituent group made of sp² carbon alone and hence is rigid and minimally deformed. Therefore, such a monomer is never shrunk through high temperature backing, and therefore, it can be used for forming an organic polymer film with a low density and a high crosslink density. Accordingly, an organic polymer film with high mechanical strength and a low dielectric constant can be thus realized.

Moreover, the organic polymer film of the invention has benzoxazole as the basic skeleton of the polymer and has a structure in which NH of imidazole with large polarizability is replaced with an ether bond. Accordingly, the hygroscopicity is lower.

### EXAMPLE

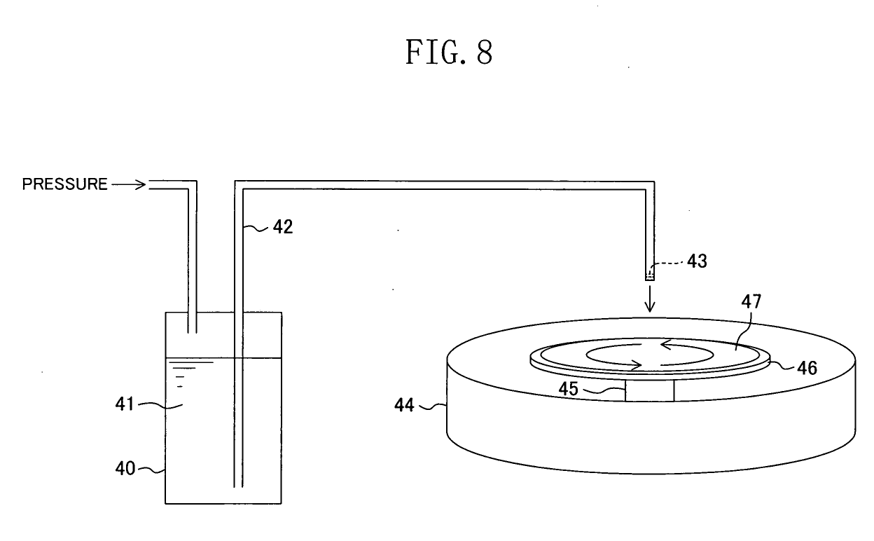

Now, a specific example of the embodiment of the invention described above, and more specifically, an example for forming an interlayer insulating film made of an organic polymer film through copolymerization of the first monomer and the second monomer performed by employing spin coating will be described with reference to FIG. 8.

First, a solution 41 is prepared in a chemical bottle 40 by dissolving 300 mg of a carboxylic acid derivative (with a molecular weight of 616.7) having an adamantane skeleton obtained as the first monomer by employing the combination 1a of Table 1 and 650 mg of an amine derivative (with a molecular weight of 1336.5) having an adamantane skeleton obtained as the second monomer by employing the combination 2a of Table 2 in 20 ml of dimethyl acetamide. Next, the chemical bottle 40 is pressed with a pressure of a helium gas, so that 1 ml of the solution 41 can be dropped onto a silicon wafer (semiconductor substrate) 46 with a diameter of 300 mm placed on a rotational support 45 in a coater cup 44 through a chemical nozzle 42 and though a filter 43 made of, for example, fluororesin (poly tetrafluoroethylene) with a pore diameter of 0.2 μm. Then, the spin coating is performed for 30 seconds with the number of revolutions of the silicon wafer 46 set to 3000 rpm, so as to form a thin film 47 on the silicon wafer 46.

Next, the silicon wafer 46 on which the thin film 47 has been formed is backed with a hot plate at a temperature of 180° C. for 100 seconds so as to evaporate the solvent from the thin film 47. Thereafter, the backing is further performed with a hot plate at a temperature of 300° C. for 10 minutes. Subsequently, the resultant wafer is further backed with an electric furnace at a temperature of 400° C. for 30 minutes in a nitrogen atmosphere. In this manner, a copolymerization reaction between the first monomer and the second monomer is proceeded in the thin film 47, resulting in forming an interlayer insulating film made of an organic polymer film on the silicon wafer 46.

The thickness of the thus obtained interlayer insulating film measured with a spectropic ellipsometer is 330 nm. Also, the dielectric constant of the interlayer insulating film measured with a mercury prober is 2.1. The dielectric constant of, for example, a bulk material of polyoxazole is approximately 2.6, and thus, an interlayer insulating with a lower dielectric constant can be formed by the method of this example.

In this example, the monomer including the carboxylic acid derivative having the adamantane skeleton shown in Table 1 as the combination 1a having four polymeric functional groups is used as the first monomer, and the monomer including the amine derivative having the adamantane skeleton shown in Table 2 as the combination 2a having four polymeric functional groups is used as the second monomer. Instead, the solution may be prepared by combining one or plural kinds of first monomer selected from the combinations 1a through 1h listed in Table 1 and one or plural kinds of second monomer selected from the combinations 2a through 2p listed in Table 2 and the combinations 3a through 3p listed in Table 3, and for example, a monomer having three polymeric functional groups (corresponding to the combination 1b of Table 1) and a monomer having four polymeric functional groups (corresponding to the combination 2a of Table 2) may be combined, a monomer having three polymeric functional groups (corresponding to the combination 1b of Table 1) and a monomer having three polymeric functional groups (corresponding to the combination 2b of Table 2) may be combined, or a monomer having two polymeric functional groups (corresponding to the combination 1c of Table 1) and a monomer having four polymeric functional groups (corresponding to the combination 2a of Table 2) may be combined. Furthermore, in this case, the number of kinds of first monomers and the number of kinds of second monomers may be the same or different.

In this manner, the crosslink density of an organic polymer film to be formed can be freely adjusted, and therefore, the mechanical strength and dielectric constant of the resultant film can be adjusted to appropriate values. Specifically, when monomers having a larger number of polymeric functional groups are combined for the polymerization, the crosslink density of a resultant organic polymer film can be higher, and hence, the organic polymer film attains high mechanical strength and a rather high dielectric constant. Alternatively, when monomers having a smaller number of polymeric functional groups are combined for the polymerization, the crosslink density of a resultant organic polymer film can be lower, and hence, the organic polymer film attains rather low mechanical strength and a low dielectric constant. In this manner, the properties of a film to be formed can be precisely controlled.

It is noted that the organic polymer film of this invention is useful as an interlayer insulating film.

What is claimed is:

1. A method for forming an organic polymer film comprising a step of copolymerizing one or plural kinds of first monomer and one or plural kinds of second monomer,
said first monomer including a carboxylic acid derivative having an adamantane skeleton represented by the following Chemical Formula 1 and determined in accordance with selection of X₁, X₂, X₃ and X₄ in Chemical Formula 1: 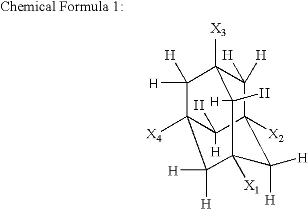
wherein each of X₁, X₂, X₃ and X₄ is one selected from the group consisting of a substituent group represented by the following Chemical Formula 2, a substituent group represented by the following Chemical Formula 3, a hydrogen atom, an aliphatic group and an aromatic group, and at least one of X₁, X₂, X₃ and X₄ is said substituent group represented by Chemical Formula 2 or said substituted group represented by Chemical Formula 3: 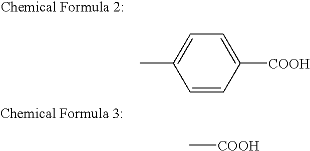
said second monomer including an amine derivative having an adamantane skeleton represented by the following Chemical Formula 4 and determined in accordance with selection of Y₁, Y₂, Y₃ and Y₄ in Chemical Formula 4:
Chemical Formula 4: 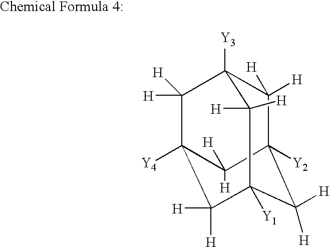
wherein each of Y₁, Y₂, Y₃ and Y₄ is one selected from the group consisting of substituent groups respectively represented by the following Chemical Formula 5, 6, 7, 8, 9, 10, 11 and 12, a hydrogen atom, an aliphatic group and an aromatic group, and at least one of Y₁, Y₂, Y₃ and Y₄ is one of said substituent groups respectively represented by Chemical Formula 5, 6, 7, 8, 9, 10, 11 and 12:

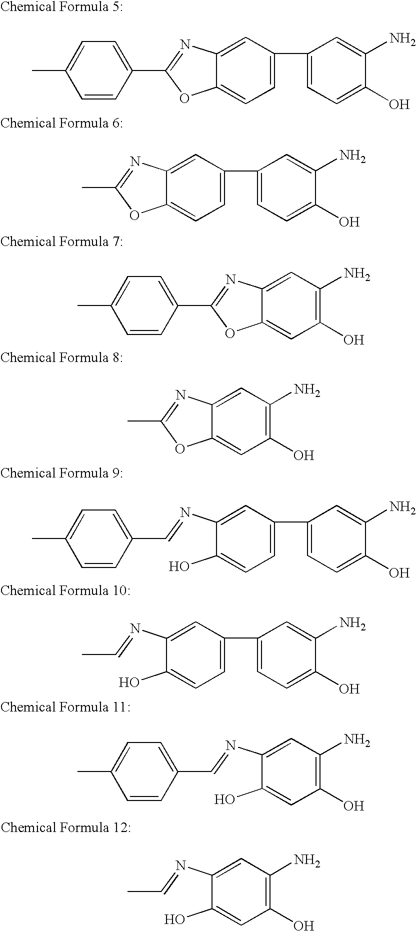

2. The method for forming an organic polymer film of claim 1,
wherein the number of kinds of first monomer and the number of kinds of second monomer is the same or different.

3. A method for forming an organic polymer film comprising the steps of:
applying a solution on a substrate, said solution including one or plural kinds of first monomer and one or plural kinds of second monomer; and
copolymerizing, through backing, said one or plural kinds of first monomer and said one or plural kinds of second monomer included in said solution applied on said substrate,
said first monomer including a carboxylic acid derivative having an adamantane skeleton represented by the following Chemical Formula 13 and determined in accordance with selection of X₁, X₂, X₃ and X₄ in Chemical Formula 13: 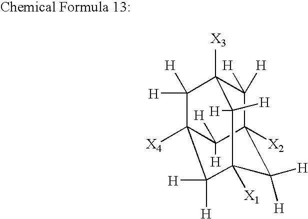
wherein each of X₁, X₂, X₃ and X₄ is one selected from the group consisting of a substituent group represented by the following Chemical Formula 14, a substituent group represented by the following Chemical Formula 15, a hydrogen atom, an aliphatic group and an aromatic group, and at least one of X₁, X₂, X₃ and X₄ is said substituent group represented by Chemical Formula 14 or said substituted group represented by Chemical Formula 15: 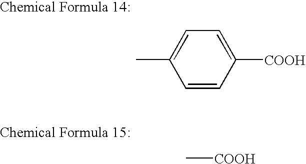
said second monomer including an amine derivative having an adamantane skeleton represented by the following Chemical Formula 16 and determined in accordance with selection of Y₁, Y₂, Y₃ and Y₄ in Chemical Formula 16: 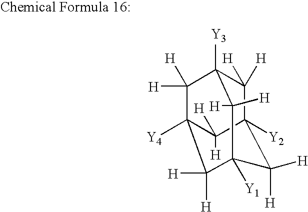
wherein each of Y₁, Y₂, Y₃ and Y₄ is one selected from the group consisting of substituent groups respectively represented by the following Chemical Formula 17, 18, 19, 20, 21, 22, 23 and 24, a hydrogen atom, an aliphatic group and an aromatic group, and at least one of Y₁, Y₂, Y₃ and Y₄ is one of said substituent groups respectively represented by Chemical Formula 17, 18, 19, 20, 21, 22, 23 and 24:

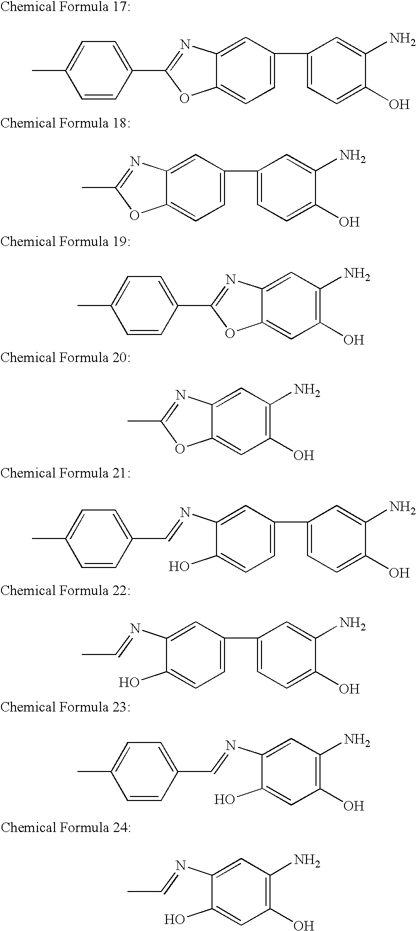

4. The method for forming an organic polymer film of claim 3,
wherein the number of kinds of first monomer and the number of kinds of second monomer is the same or different.

5. An organic polymer film comprising a polymer of one or plural kinds of first monomer and one or plural kinds of second monomer,
said first monomer including a carboxylic acid derivative having an adamantane skeleton represented by the following Chemical Formula 25 and determined in accordance with selection of X₁, X₂, X₃ and X₄ in Chemical Formula 25: 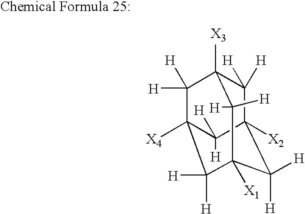
wherein each of X₁, X₂, X₃ and X₄ is one selected from the group consisting of a substituent group represented by the following Chemical Formula 26, a substituent group represented by the following Chemical Formula 27, a hydrogen atom, an aliphatic group and an aromatic group, and at least one of X₁, X₂, X₃ and X₄ is said substituent group represented by Chemical Formula 26 or said substituted group represented by Chemical Formula 27: 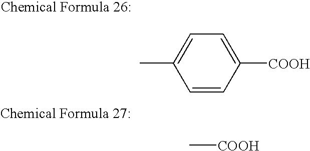
said second monomer including an amine derivative having an adamantane skeleton represented by the following Chemical Formula 28 and determined in accordance with selection of Y₁, Y₂, Y₃ and Y₄ in Chemical Formula 28: 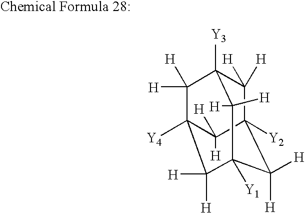
wherein each of Y₁, Y₂, Y₃ and Y₄ is one selected from the group consisting of substituent groups respectively represented by the following Chemical Formula 29, 30, 31, 32, 33, 34, 35 and 36, a hydrogen atom, an aliphatic group and an aromatic group, and at least one of Y₁, Y₂, Y₃ and Y₄ is one of said substituent groups respectively represented by Chemical Formula 29, 30, 31, 32, 33, 34, 35 and 36:

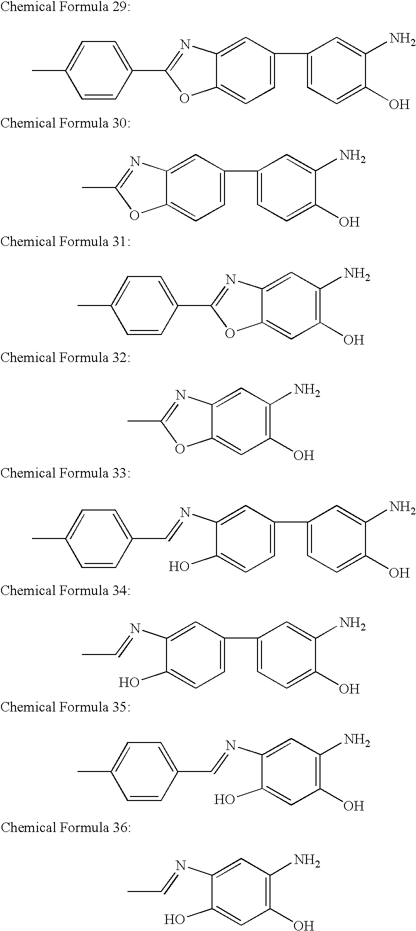

6. The organic polymer film of claim 5,
wherein the number of kinds of first monomer and the number of kinds of second monomer is the same or different.

7. A method for forming an organic polymer film comprising a step of copolymerizing a first monomer and a second monomer,
wherein in the step of copolymerizing a first monomer and a second monomer, said first monomer is a monomer including an adamantane derivative in which a substituent group having a carbon number of 1 or more, a functional group or a functional group bonded to a substituent group is bonded to at least three positions out of the 1-, 3-, 5- and 7-positions of an adamantane skeleton, at least one of functional groups is a carboxyl group, and a substituent group bonded to a functional group is an aromatic group, and
said second monomer is a monomer including an adamantane derivative in which a substituent group having a carbon number of 1 or more, a functional group or a functional group bonded to a substituent group is bonded to at least three positions out of the 1-, 3-, 5- and 7-positions of an adamantane skeleton, at least one of functional groups is a hydroxyl group, and a substituent group bonded to a functional group is an aromatic group.

8. The method for forming an organic polymer film of claim 8,
wherein said first monomer includes a carboxylic acid derivative having an adamantane skeleton represented by the following Chemical Formula 37: 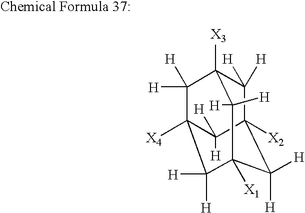
wherein each of X₁, X₂, X₃ and X₄ is one selected from the group consisting of a substituent group represented by the following Chemical Formula 38, a substituent group represented by the following Chemical Formula 39, a hydrogen atom, an aliphatic group and an aromatic group, and at least one of X₁, X₂, X₃ and X₄ is said substituent group represented by Chemical Formula 38 or said substituted group represented by Chemical Formula 39: 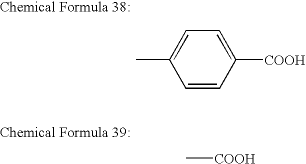
said second monomer includes an amine derivative having an adamantane skeleton represented by the following Chemical Formula 40: 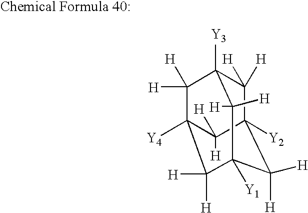
wherein each of Y₁, Y₂, Y₃ and Y₄ is one selected from the group consisting of substituent groups respectively represented by the following Chemical Formula 41, 42, 43, 44, 45, 46, 47 and 48, a hydrogen atom, an aliphatic group and an aromatic group, and at least one of Y₁, Y₂, Y₃ and Y₄ is one of said substituent groups respectively represented by Chemical Formula 41, 42, 43, 44, 45, 46, 47 and 48: 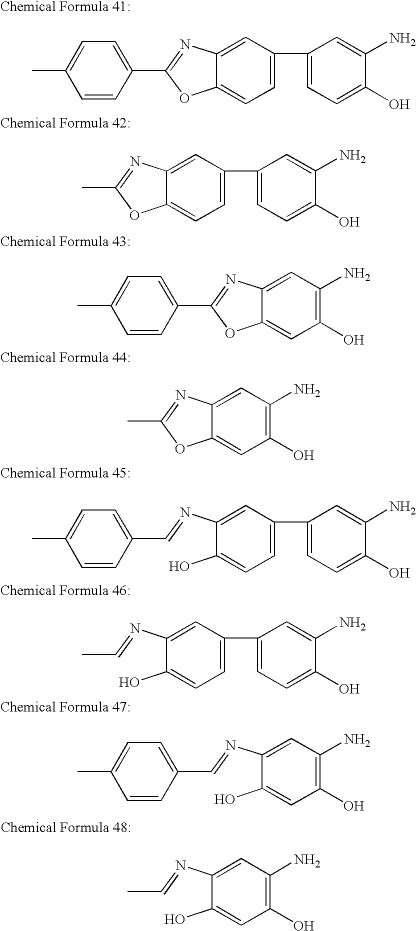
and
one or plural kinds of first monomer determined in accordance with selection of said X₁, X₂, X₃ and X₄ and one or plural kinds of second monomer determined in accordance with selection of said Y₁, Y₂, Y₃ and Y₄ are copolymerized in the step of copolymerizing a first monomer and a second monomer.

9. An organic polymer film comprising a copolymer of a first monomer and a second monomer,
wherein said first monomer is a monomer including an adamantane derivative in which a substituent group having a carbon number of 1 or more, a functional group or a functional group bonded to a substituent group is bonded to at least three positions out of the 1-, 3-, 5- and 7-positions of an adamantane skeleton, at least one of functional groups is a carboxyl group, and a substituent group bonded to a functional group is an aromatic group, and
said second monomer is a monomer including an adamantane derivative in which a substituent group having a carbon number of 1 or more, a functional group or a functional group bonded to a substituent group is bonded to at least three positions out of the 1-, 3-, 5- and 7-positions of an adamantane skeleton, at least one of functional groups is a hydroxyl group, and a substituent group bonded to a functional group is an aromatic group.

10. The organic polymer film of claim 9,
wherein said first monomer includes a carboxylic acid derivative having an adamantane skeleton represented by the following Chemical Formula 49: 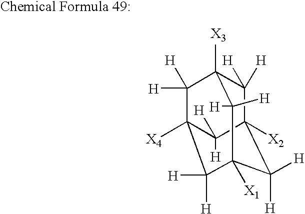
wherein each of X₁, X₂, X₃ and X₄ is one selected from the group consisting of a substituent group represented by the following Chemical Formula 50, a substituent group represented by the following Chemical Formula 51, a hydrogen atom, an aliphatic group and an aromatic group, and at least one of X₁, X₂, X₃ and X₄ is said substituent group represented by Chemical Formula 50 or said substituted group represented by Chemical Formula 51: 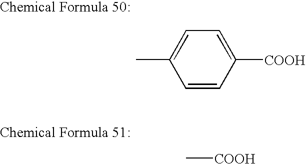
said second monomer includes an amine derivative having an adamantane skeleton represented by the following Chemical Formula 52: 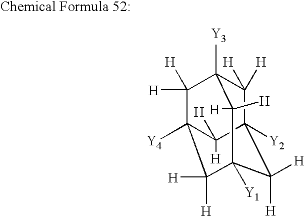
wherein each of Y₁, Y₂, Y₃ and Y₄ is one selected from the group consisting of substituent groups respectively represented by the following Chemical Formula 53, 54, 55, 56, 57, 58, 59 and 60, a hydrogen atom, an aliphatic group and an aromatic group, and at least one of Y₁, Y₂, Y₃ and Y₄ is one of said substituent groups respectively represented by Chemical Formula 53, 54, 55, 56, 57, 58, 59 and 60: 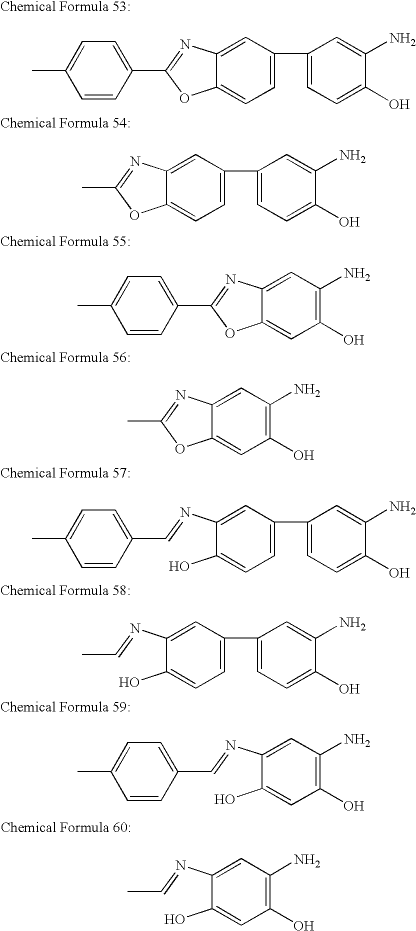
and
said copolymer is a copolymer of one or plural kinds of first monomer determined in accordance with selection of said X₁, X₂, X₃ and X₄ and one or plural kinds of second monomer determined in accordance with selection of said Y₁, Y₂, Y₃ and Y₄.
